(19) United States
(12) Patent Application Publication
(10) Pub. No.: US 2025/0158683 A1
(43) Pub. Date: May 15, 2025

(54) METHOD FOR TRANSMITTING CHANNEL STATE INFORMATION REFERENCE SIGNAL

(71) Applicant: Samsung Electronics Co., Ltd., Suwon-si (KR)

(72) Inventors: Davydov ALEXEI, Saratov (RU); Denis ESIUNIN, Saratov (RU); Dikarev DMITRY, Saratov (RU); Ermolaev GREGORY, Saratov (RU); Morozov GREGORY, Saratov (RU); Pestretsov VLADIMIR, Saratov (RU)

(21) Appl. No.: 18/912,142

(22) Filed: Oct. 10, 2024

(30) Foreign Application Priority Data
Nov. 13, 2023 (RU) 2023129351

(51) Int. Cl. H04B 7/06; H04L 5/00; H04L 27/26

(52) U.S. Cl. CPC H04B 7/0626; H04L 5/0007; H04L 27/263

(57) ABSTRACT

The present disclosure relates to a 5G communication system or a 6G communication system for supporting higher data rates beyond a 4G communication system such as long term evolution (LTE). The disclosure relates to a method for transmitting channel state information reference signal (CSI-RS). The technical result includes increased performance and flexibility of CSI-RS generation and transmission framework, unified CSI-RS structure, and reduced transmission overhead. A method for transmitting channel state information reference signal is provided. The method includes setting, at a base station, CSI-RS transmission configuration information, including one or more code-division multiplexing (CDM) groups with uniform frequency distribution of resource elements (RE) in each CDM group, transmitting the CSI-RS transmission configuration information from the base station (BS) to user equipment (UE), generating, for each antenna port of the base station, a CSI-RS modulated by orthogonal cover code (OCC) in frequency domain (FD) across resource elements according to discrete Fourier transform (DFT) vector and in time domain (TD) across one or more Orthogonal Frequency-Division Multiplexing (OFDM) symbols according to Walsh-Hadamard (WH) code, and transmitting the CSI-RS from the BS to the UE according to the CSI-RS transmission configuration.

### CROSS-REFERENCE TO RELATED APPLICATION(S)

This application is based on and claims priority under 35 U.S.C. § 119 (a) of a Russian patent application number 2023129351, filed on Nov. 13, 2023, in the Russian Intellectual Property Office, the disclosure of which is incorporated by reference herein in its entirety.

### BACKGROUND

### 1. Field

The disclosure relates to wireless communication. More particularly, the disclosure relates to a method for transmitting channel state information reference signal.

### 2. Description of Related Art

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

Massive multiple-input-multiple-output (mMIMO) framework in fifth generation (5G) new radio (5G NR) communication standard increases spectral efficiency performance due to the use of antenna systems with multiple antenna elements and advanced processing schemes.

Extreme MIMO (xMIMO) antenna systems for future sixth generation (6G) communication standard are designed to provide even better performance due to support of even larger antenna arrays and wider system bandwidth.

To enable mMIMO and xMIMO operation, channel state information (CSI) feedback can be used:
reciprocity based, where sounding reference signal (SRS) is used to provide channel measurements at base station (BS),
codebook based, where quantized CSI is calculated by user equipment (UE) and provided to BS using uplink control information (UCI).

To support codebook based CSI feedback, channel state information reference signal (CSI-RS) is transmitted by the BS to the UE.

The CSI-RS of the related art in 5G NR supports up to 32 antenna ports, and is also modulated by quadrature phase shift keying (QPSK) symbols and transmitted over system bandwidth.

However, the current CSI-RS structure is not sufficient to support xMIMO operation with more than 32 antenna ports, e.g., up to 256.

Subject to TS 38.211 “NR; Physical channels and modulation” v17.5.0 dated Jun. 26, 2023, CSI-RS structure for 5G NR offers the key features:
CSI-RS is QPSK modulated using pseudo-random sequence;
configurable bandwidth (BW) and common reference point for sequence generation;
support of up to 32 antenna ports;
signal density (number of resource elements per antenna port) is selected from 0.5, 1, 3 (for 1 port only);
aperiodic, semi-persistent, and periodic transmission of CSI-RS in the same slot;
Code division multiplexing (CDM) groups always contain adjacent resource elements (RE).

Furthermore, CSI-RS port multiplexing offers:
multiplexing options: time-domain orthogonal cover code (TD-OCC), frequency-domain orthogonal cover code (FD-OCC), frequency-division multiplexing (FDM), time division multiplexing (TDM);
non-uniform distribution of REs per each CDM group except for CSI-RS with one port;
port indexing: in the CDM group first, then across CDM groups in the frequency domain, and then in the time domain.

Owing to the above features of CSI-RS structure for 5G NR, adjacent REs in CDM group may not allow transmission of other reference signals within the same group, i.e., inclined to possible scheduling restrictions. CSI-RSs are always transmitted in the same slot, consuming large amount of resources. The CSI-RS structure with non-uniform CDM groups is only suitable for cyclic prefix orthogonal frequency-division multiplexing (CP-OFDM) and could not be extended for low peak-to-average power ratio (PAPR) waveform.

6G communication system deployed in upper mid-band frequency band (10-12 GHZ) should support a larger number of antenna ports than 5G NR provides (i.e., more than 32), because 6G system assumes the use of antenna arrays with an extremely large number of antenna ports (xMIMO). Moreover, more CSI-RS signals will be needed to obtain channel characteristics of these ports, because in the simplest xMIMO scenario one antenna port requires configuration and transmission of one CSI-RS signal.

Therefore, the existing CSI-RS structure for 5G NR described above is not sufficient to support 6G communication systems due to the following problems:
maximum number of CSI-RS antenna ports (up to 32) is less than the number required for 6G xMIMO (up to 256);
5G NR CSI-RS structure supports only CP-OFDM without possibility to extend to low PAPR waveforms;
5G NR CSI-RS structure is not flexible enough to enable simultaneous transmission of other reference signals;
5G NR overhead reduction is not optimized for sub-band structure;
CSI-RS transmission is always limited to the same slot;
port indexing doesn't support CSI-RS resource sharing with different numbers of ports.

Thus, there is a need in the art for a method for generating and transmitting CSI-RS, having higher flexibility and performance and applicable in 6G xMIMO systems.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method for transmitting channel state information reference signal.

Additional aspects will be set forth in part in the description which follows and, in part, will be apparent from the description, or may be learned by practice of the presented embodiments.

In accordance with an aspect of the disclosure, a method for transmitting channel state information reference signal (CSI-RS) is provided. The method includes setting, at a base station, CSI-RS transmission configuration information, including one or more code-division multiplexing (CDM) groups with uniform frequency distribution of resource elements (RE) in each CDM group, transmitting the CSI-RS transmission configuration information from the base station (BS) to user equipment (UE), generating, for each antenna port of the base station, a CSI-RS modulated by orthogonal cover code (OCC) in frequency domain (FD) across resource elements according to discrete Fourier transform (DFT) vector and in time domain (TD) across one or more OFDM symbols according to Walsh-Hadamard (WH) code, and transmitting the CSI-RS from the BS to the UE according to the CSI-RS transmission configuration.

In an embodiment of the disclosure, the CSI-RS transmission configuration information further includes at least one of information on the number of ports, information on the number of CDM groups, length of OCC in time and frequency, CSI-RS port indexing information, used CSI-RS waveform, used OFDM symbols and slots, physical resource block (PRB) groups where CSI-RS is present.

In another embodiment of the disclosure, the generating of the CSI-RS comprises modulating the CSI-RS sequence by quadrature phase shift keying (QPSK) symbols obtained based on pseudo random sequence.

In another embodiment of the disclosure, the generating of the CSI-RS comprises modulating the CSI-RS sequence by π/2 binary phase shift key (π/2-BPSK) symbols obtained based on pseudo random sequence.

In another embodiment of the disclosure, the generating of the CSI-RS comprises modulating the CSI-RS sequence by Zadoff-Chu (ZC) sequence.

In another embodiment of the disclosure, the group of PRBs comprises two or more adjacent PRBs, the PRB groups being separated from each other by same or similar distance in the frequency domain.

In another embodiment of the disclosure, the CDM group is transmitted on non adjacent OFDM symbols in a slot.

In another embodiment of the disclosure, actual OFDM symbols for CSI-RS are indicated to the UE using signaling.

In another embodiment of the disclosure, actual OFDM symbols for CSI-RS are determined by the base station by delaying subsequent transmission of all or part of OFDM symbols of the CSI-RS to later OFDM symbol in case of collision with the transmission of other signals.

In another embodiment of the disclosure, the other signal is a tracking reference signal (TRS) transmitted by the BS.

In another embodiment of the disclosure, first and last symbols of the CSI-RS are on different slots.

In another embodiment of the disclosure, a subset of CSI-RS ports are transmitted on one slot and another subset of CSI-RS ports are transmitted on another slot.

In another embodiment of the disclosure, the first and the second subsets of antenna ports correspond to different polarizations.

In another embodiment of the disclosure, CSI-RS corresponding to smaller number of antenna ports is subset of CSI-RS corresponding to larger number of antenna ports.

In another embodiment of the disclosure, indexing of antenna ports for CSI-RS is performed in the following order across CDM groups first, and then by OCC code inside CDM groups.

In accordance with another aspect of the disclosure, a method of communicating in a communication system including at least one base station and at least one user equipment is provided. The method includes transmitting CSI-RS from base station to the user equipment, receiving the CSI-RS by the user equipment based on received CSI-RS configuration, measuring, by the user equipment, channel characteristics from transmitting ports of the base station and obtaining channel state information, transmitting the channel state information to the base station, selecting, by the base station based on the channel state information, transmission parameters for physical downlink shared channel (PDSCH), and generating and transmitting, by the base station, signals to the user equipment on the PDSCH channel.

In an embodiment of the disclosure, the transmission parameters for PDSCH include spatial precoding matrix, modulation scheme, and noise-resistant coding rate for PDSCH.

In accordance with another aspect of the disclosure, a base station in a communication system including a user equipment is provided. The base station is configured to set channel state information reference signal (CSI-RS) transmission configuration information including one or more CDM groups with uniform frequency distribution of resource elements (RE) in each CDM group, transmit the CSI-RS transmission configuration information to a user equipment (UE), generate, for each antenna port of the base station, a CSI-RS modulated by OCC in the frequency domain (FD) across resource elements according to discrete Fourier transform (DFT) vector and in the time domain (TD) across one or more OFDM symbols according to Walsh-Hadamard (WH) code, and transmit the CSI-RS to the UE according to the CSI-RS transmission configuration.

In accordance with another aspect of the disclosure, one or more non-transitory computer-readable storage media storing computer-executable instructions that, when executed by one or more processors individually or collectively, cause a base station to perform operations is provided. The operations include setting, at a base station, CSI-RS transmission configuration information, including one or more code-division multiplexing (CDM) groups with uniform frequency distribution of resource elements (RE) in each CDM group, transmitting the CSI-RS transmission configuration information from the base station (BS) to user equipment (UE), generating, for each antenna port of the base station, a CSI-RS modulated by orthogonal cover code (OCC) in frequency domain (FD) across resource elements according to discrete Fourier transform (DFT) vector and in time domain (TD) across one or more orthogonal frequency-division multiplexing (OFDM) symbols according to Walsh-Hadamard (WH) code, and transmitting the CSI-RS from the BS to the UE according to said CSI-RS transmission configuration.

The disclosure offers higher performance and flexibility of CSI-RS generation and transmission framework, unified CSI-RS structure, and reduced transmission overhead.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic view illustrating distribution of resource elements in one CDM group according to an embodiment of the disclosure;

FIG. 2 illustrates sequential resource elements in frequency domain (left) and time domain (right), to which OCC elements from same CDM group are mapped according to an embodiment of the disclosure;

FIG. 3 is an CSI-RS structure according to an embodiment of the disclosure;

FIGS. 4A, 4B, and 4C are flow diagrams illustrating CSI-RS modulation algorithm for xMIMO according to various embodiments of the disclosure;

FIGS. 5A, 5B, and 5C show PRB distribution for CSI-RS according to various embodiments of the disclosure;

FIG. 6 illustrates CSI-RS structure in a time domain in case of collision with other reference signals in related art according to an embodiment of the disclosure;

FIG. 7 illustrates CSI-RS transmission on two adjacent slots in 6G system according to an embodiment of the disclosure;

FIG. 8 illustrates CSI-RS transmission by two groups of antenna ports on two different slots in 6G system according to an embodiment of the disclosure;

FIG. 9 illustrates two groups of antenna ports with different polarizations for CSI-RS transmission according to a transmission of FIG. 8 according to an embodiment of the disclosure;

FIG. 10 is CSI-RS structure with resources shared for a different number of antenna ports according to an embodiment of the disclosure;

FIG. 11 is a schematic view illustrating indexing antenna ports for CSI-RS according to an embodiment of the disclosure;

FIG. 12 is a schematic view illustrating antenna ports transmitting CSI-RSs received by user equipment in accordance with a signal structure of FIG. 11 according to an embodiment of the disclosure;

FIG. 13 is a flow diagram illustrating a method of communicating in communication system according to an embodiment of the disclosure;

FIG. 14 is a block diagram of a terminal according to embodiments of the disclosure; and

FIG. 15 is a block diagram of a base station according to embodiments of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Structure of channel state information reference signal (CSI-RS) in accordance with the disclosure is described hereinafter.

In accordance with the disclosure, multiple (CDM CDM) groups have uniform frequency distribution of resource elements in each CDM group (transmission comb). CDM group is a set of subcarriers, where several signals with orthogonal sequences can be multiplexed.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

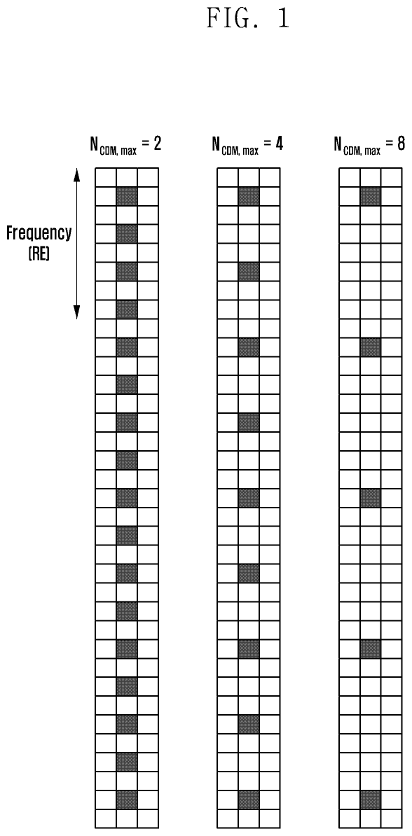

FIG. 1 is a schematic view illustrating distribution of resource elements (subcarriers) in one CDM group according to an embodiment of the disclosure.

Referring to FIG. 1, N_{CDM,max}=2, where N_{CDM,max} is the specified maximum number of CDM groups. A second CDM group can be obtained by shifting the depicted comb by one subcarrier.

Similarly, in FIG. 1, center and right side, shows uniform distribution of resource elements in the same CDM group, at N_{CDM,max}=4 and N_{CDM,max}=8, respectively. Other CDM groups can also be obtained by shifting the displayed comb.

The uniform frequency REs in the CDM group support low PAPR waveform.

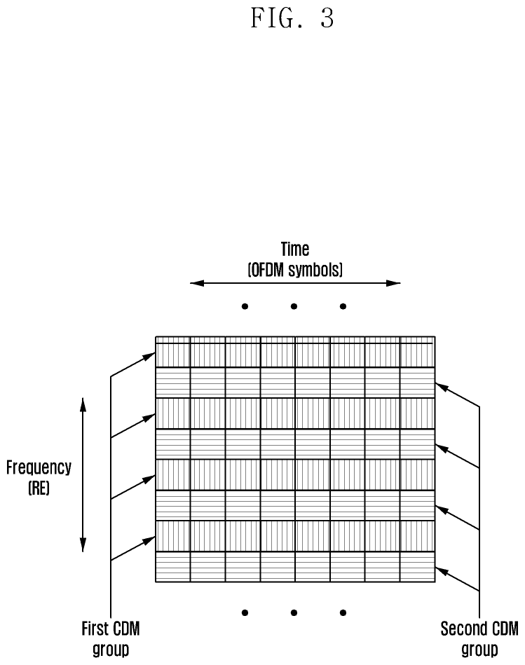

Upon generating CDM groups with uniform frequency distribution of resource elements, an orthogonal code division is applied to each CDM group. This approach is illustrated in FIG. 3, where different hatching (horizontal and vertical) shows two CDM groups with uniform frequency distribution of resource elements and continuous time distribution of resource elements. In the frequency domain, CDM groups in FIG. 3 are shifted relative to each other by one frequency interval between subcarriers. CSI-RS signals transmitted by different antenna ports on the same resource elements within each CDM group are multiplexed using code division, particularly, combined use of orthogonal frequency (FD-OCC) and time (TD-OCC) codes.

In the frequency domain inside a CDM group, Discrete Fourier Transform (DFT) codes are used for division. Thus, in the frequency domain (FD) according to the disclosure, cyclic shifts are used to multiplex multiple CSI-RS antenna ports in the same CDM group using DFT codes.

DFT-based FD-OCC offers low complexity Fast Fourier Transform (FFT) channel estimation and low PAPR waveform. w_{f}(k′) element of the FD-OCC sequence (i.e., the element of code division sequence, or multiplexing, mapped to serial resource elements (RE) in the frequency domain) obtained by discrete Fourier transform is defined as follows:

$${w}_{f} ( {k}^{′} ) = \{ {e}^{- 2 π j \frac{{k}_{f}}{{N}_{f , max}} {k}^{′}} \} \qquad Equation 1$$

where k′ is the RE index in the CDM group, N_{f,max}s the number of orthogonal codes in the frequency domain, k_{f} is a variable that uniquely corresponds to FD-OCC code index in one CDM group, k_{f}=0, 1, . . . , (N_{f,max}−1) is an imaginary unit.

Time domain (TD) of the disclosure uses binary Walsh-Hadamard sequence to multiplex multiple CSI-RS antenna ports across multiple Orthogonal Frequency-Division Multiplexing (OFDM) symbols of the CDM group.

WH-based TD-OCC is easier to implement and more robust to frequency offsets compared to OCC codes obtained with DFT. wₜ(l′) element of a TD-OCC sequence (i.e., the element of code division or multiplexing sequence mapped to sequential resource elements (RE) in time domain) derived from orthogonal Walsh-Hadamard sequences is defined as:

$$\{ \begin{matrix}⋮ \\ {w}_{t} ( {l}^{′} ) \\ ⋮\end{matrix} \} = {w}_{{N}_{t , max}} = \{ \begin{matrix}W \frac{{N}_{t , max}}{2} & W \frac{{N}_{t , max}}{2} \\ W \frac{{N}_{t , max}}{2} & - W \frac{{N}_{t , max}}{2}\end{matrix} \}$$

where l′ is the index of the OFDM symbol in the CDM group, N_{t,max} the number of OFDM symbols that defines the code length in the time domain, W_{N}_{_{t,max}} a variable denoting a set of Walsh-Hadamard sequences (or Walsh-Hadamard matrix, where individual columns of the matrix represent separate sequences). The use of W_{N}_{_{t,max}} Equation 2 demonstrates how a set of Walsh-Hadamard sequences can be recurrently obtained from a set of Walsh-Hadamard sequences of half as small length.

In a special case, at N_{t,max}=2quation 2 takes the form:

$${W}_{2} = \{ \begin{matrix}1 & 1 \\ 1 & - 1\end{matrix} \} .$$

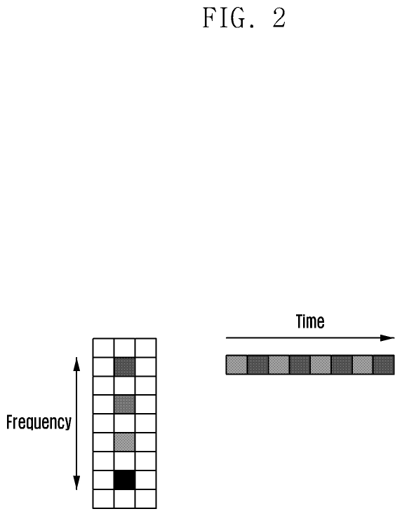

FIG. 2 illustrates sequential resource elements in frequency domain (left side) and time domain (right side) to which orthogonal cover code (OCC) elements from same CDM group are mapped according to an embodiment of the disclosure.

Thus, the left side shows FD-OCC CDM group, and the right side shows TD-OCC CDM group. Moreover, while in the time domain (right side) the elements are arranged continuously, in the frequency domain (left side) resource elements of the CSI-RS CDM group are interlaced with resource elements not occupied by this CSI-RS signal. Free resource elements between resource elements of one CDM group in the frequency domain can be used to transmit CSI-RS to another CDM group. Thereby, frequency division between the CDM groups of CSI-RS signals is achieved. As seen in FIG. 2, N_{f,max}=4or CDM group in the frequency domain), and N_{t,max}=8or CDM group in the time domain).

Maximum number N_{p,max} antenna ports for CSI-RS is defined by the equation:

$${N}_{p , max} = {N}_{f , max} \cdot {N}_{t , max} \cdot {N}_{CDM , max} ion 3$$

FIG. 3 illustrates a CSI-RS structure according to an embodiment of the disclosure.

Referring to FIG. 3, it illustrates an CSI-RS structure for the case, where N_{CDM,max}=2 _(f,max)=4 and N_{t,max}. Thus, the maximum number of antenna ports for this CSI-RS structure is 64.

Table 1 below shows possible CSI-RS configurations with different N_{CDM,max} _(f,max) and N_{t,max} lues

TABLE 1

| CSI-RS | | | | |
|---|---|---|---|---|
| Configuration Index | N_{P, max} | N_{f, max} | N_{t, max} | N_{CDM, max} |
| 0 | 256 | 8 | 8 | 4 |
| 1 | 192 | 6 | 8 | 4 |
| 2 | 144 | 9 | 4 | 4 |
| 3 | 128 | 8 | 4 | 4 |
| 4 | 128 | 4 | 8 | 4 |
| 5 | 96 | 6 | 4 | 4 |
| 6 | 72 | 9 | 2 | 4 |
| 7 | 64 | 4 | 4 | 4 |
| 8 | 64 | 4 | 8 | 2 |
| 9 | 48 | 6 | 4 | 2 |
| 10 | 36 | 9 | 2 | 2 |
| 11 | 32 | 4 | 4 | 2 |
| . . . | . . . | . . . | . . . | . . . |

Selection of one CSI-RS configuration from the set of configurations illustrated in Table 1 enables obtaining, through the use of appropriate parameters N_{CDM,max} _(f,max) and N_{t,max} the required number of CSI-RS antenna ports.

The actual used ports N_{P} for CSI-RS (out of N_{P,max}re selected according to the following possible port priorities:

Embodiment 1: CDM Groups 1^{st}, FD-OCC 2^{nd}, TD-OCC 3^{rd};

Function for calculating the port priority in this embodiment can be expressed as:

$$\begin{matrix}f ( {i}_{c}^{( p )} , {i}_{f}^{( p )} , {i}_{i}^{( p )} ) = \\ {N}_{f , max} \cdot {N}_{t , max} \cdot \\ {i}_{c}^{( p )} + {N}_{f , max} \cdot \\ {i}_{f}^{( p )} + {i}_{t}^{( p )} on 4\end{matrix}$$

where i_{c}^{(p)} is the CDM group index, i_{f}^{(p)} is the FD-OCC code index in the CDM group, iₜ^{(p)} is the TD-OCC code index in the CDM group. Equation 4 shows an example of a function that translates CDM group index i_{c}^{(p)}, FD-OCC code index i_{f}^{(p)} in CDM group and TD-OCC code index iₜ^{(p)} in CDM group to the port number p. This integer function specifies the port number of the signal depending on relevant parameters and can range from 0 to N_{f,max}·N_{t,max}·N_{CDM,max}−1 sequent embodiments of the disclosure, the function from Equation 4 will look different.

Embodiment 2: FD-OCC 1^{st}; CDM Groups 2^{nd}; TD-OCC 3^{rd};

Embodiment 3: FD-OCC 1^{st}; TD-OCC 2^{nd}; CDM Groups 3^{rd};

Embodiment 4: TD-OCC 1^{st}; FD-OCC 2^{nd}; CDM Groups 3^{rd};

Embodiment 5: CDM Groups 1^{st}; TD-OCC 2^{nd}; FD-OCC 3^{rd};

Embodiment 6: Higher Layer/Downlink Control Information (DCI) Signaling to indicate Nₚ≤N_{p,max}rts.

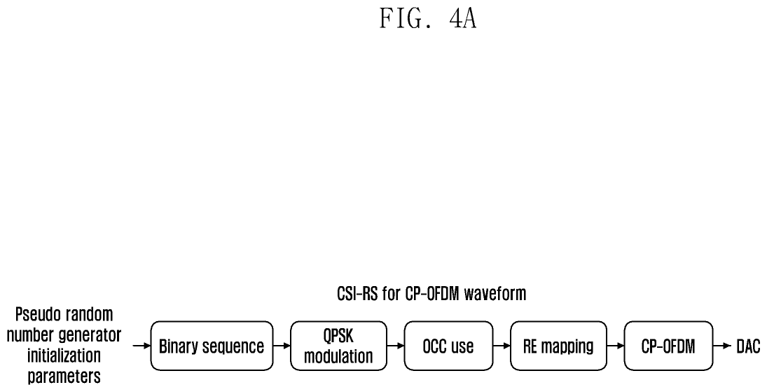

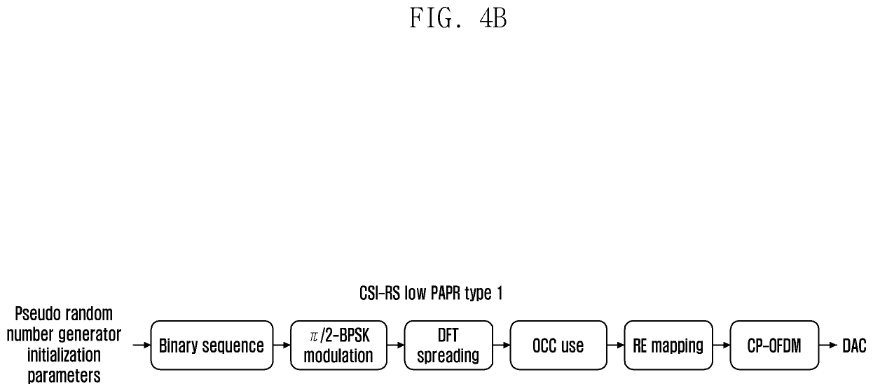

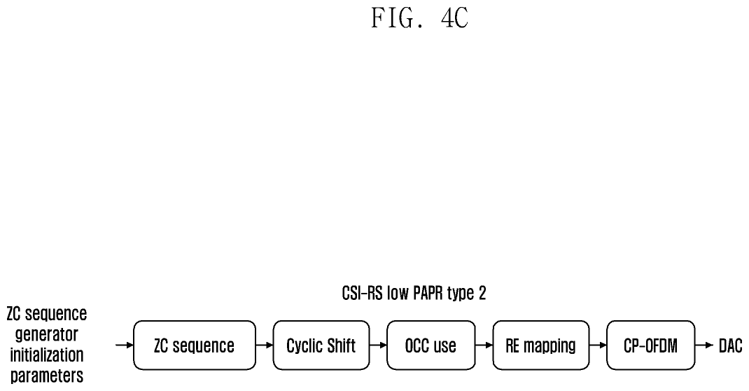

Furthermore, the disclosure can use different CSI-RS modulation schemes with different waveforms. Flow diagrams illustrating CSI-RS modulation algorithm are shown in FIGS. 4A, 4B, and 4C.

FIG. 4A is a flow diagram of the CSI-RS modulation algorithm for xMIMO according to an embodiment of the disclosure.

Referring to FIG. 4A, first, a pseudo random number generator generates pseudo random binary sequence based on initialization parameters, such as e.g., time slot number, OFDM symbol number in slot, and other parameters configurable by radio resource control (RRC) protocol. The generated binary sequence is modulated by QPSK symbols. After modulation, OCC codes obtained in accordance with the procedures described herein are applied to the sequence. The resulting sequence modulates CSI-RS resource elements. Here, methods for distributing resource elements in each CDM group are used, as provided herein. The result is fed to CP-OFDM modulator. Next, discrete samples of obtained CP-OFDM signal are subjected to digital-to-analog conversion (DAC). The signal then enters the RF path.

FIG. 4B is a flow diagram illustrating an alternative CSI-RS modulation algorithm according to an embodiment of the disclosure.

Referring to FIG. 4B, first, a pseudo random number generator similarly generates pseudo random binary sequence based on initialization parameters, such as time slot number, OFDM symbol number in slot, and other parameters configurable by the RRC protocol. The binary sequence is modulated by π/2 binary phase shift key symbols (π/2-BPSK modulation). The resulting sequence is subjected to DFT spreading. After modulation, OCC codes obtained in accordance with the procedures described herein are applied to the sequence. The obtained sequence further modulates CSI-RS resource elements. Here, methods for distributing resource elements in each CDM group are used, as provided herein. The result is fed to CP-OFDM modulator. Next, discrete samples of the obtained CP-OFDM signal are subjected to digital-to-analog conversion (DAC). The signal then enters the RF path. This algorithm ensures low PAPR.

FIG. 4C is a flow diagram illustrating another alternative CSI-RS modulation algorithm according to an embodiment of the disclosure.

Referring to FIG. 4C, first, a generator generates Zadoff-Chu sequence based on one or more initialization parameters, such as temporary slot number, OFDM symbol number in slot, and other parameters configurable by RRC protocol. The ZC sequence is subjected to cyclic shift. After the cyclic shift, the OCC codes obtained in accordance with the procedures described herein are applied to the sequence. The resulting sequence further modulates CSI-RS resource elements. Methods for distributing resource elements in each CDM group are used, as provided herein. The result is fed to CP-OFDM modulator. Next, discrete samples of the obtained CP-OFDM signal are subjected to digital-to-analog conversion (DAC). The signal then enters the RF path. This algorithm ensures low PAPR.

Thus, the disclosure supports various CSI-RS configurations with different number of antenna ports (up to 256) and different waveforms using unified structure.

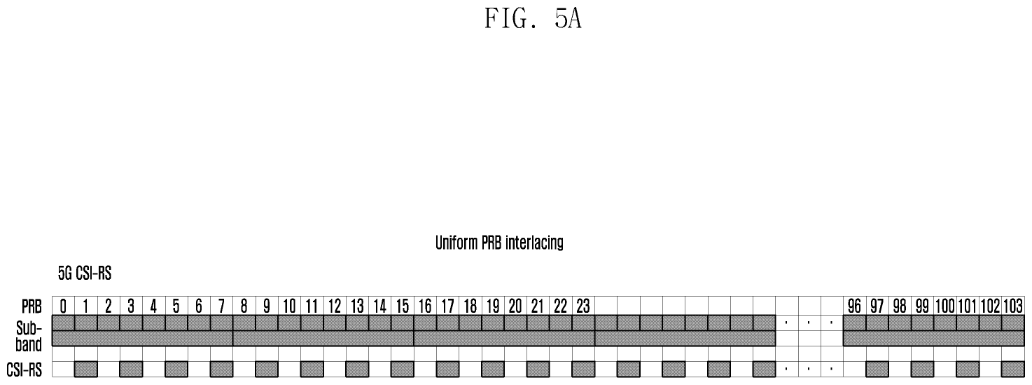

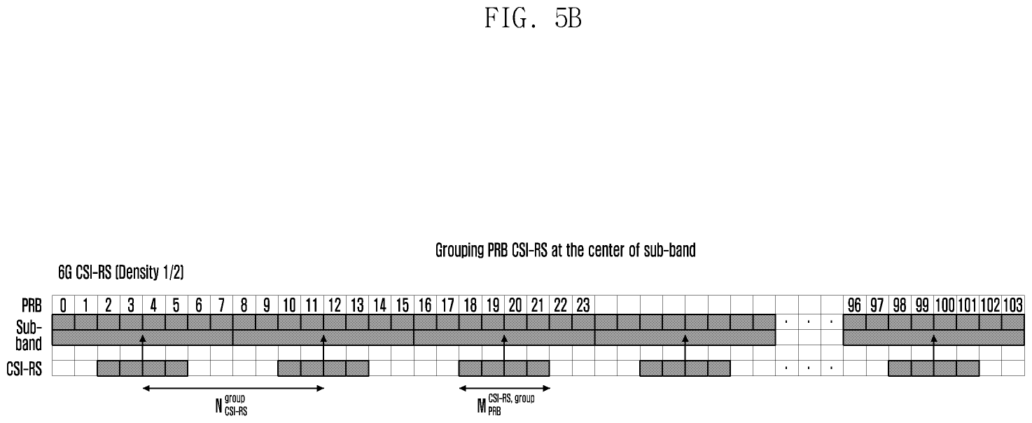

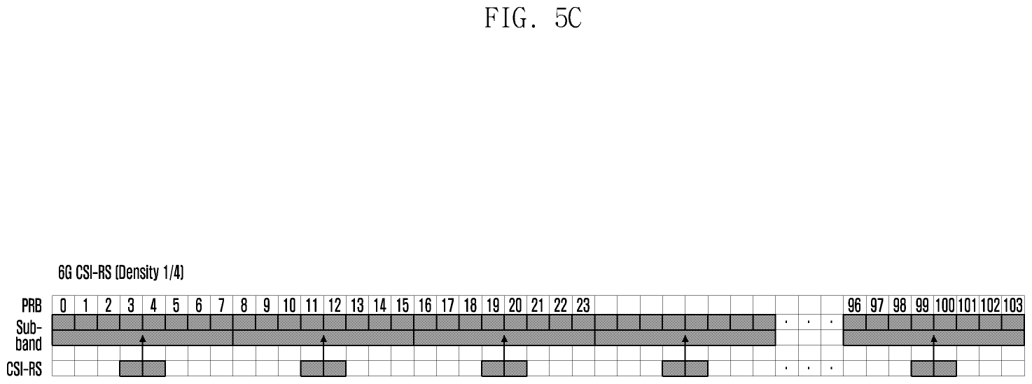

FIGS. 5A, 5B, and 5C show PRB distribution for CSI-RS according to various embodiments of the disclosure.

Referring to FIGS. 5A, 5B and 5C, they illustrate the distribution of CSI-RS across physical resource blocks (PRBs) in the related art and in accordance with the disclosure.

Referring to FIG. 5A, it illustrates uniform PRB interlacing across sub-band, typical of 5G NR system according to an embodiment of the disclosure. In 5G NR, this PRB allocation for CSI-RS transmission is used to reduce overhead. At the same time, with the CSI-RS structure distributed across PRB, it is more difficult to use channel coherence to improve measurement of channel frequency characteristic.

Referring to FIG. 5B, it illustrates group-PRB allocation to CSI-RS with 0.5 density according to an embodiment of the disclosure, optimized for sub-band structure. In the example, PRBs for CSI-RS are grouped at the center of sub-band. In accordance with the disclosure, given number M_{PRB}^{CSI-RS,group} of PRBs is preferably used to transmit CSI-RS in each sub-band at N_{CSI-RS}^{group} intervals, and the M_{PRB}^{CSI-RS,group} PRBs are to be contiguous. Thereby channel coherence can be used to improve channel estimation.

In most frequency-selective communication channels, the channel frequency characteristic is expected to vary slightly at subcarrier frequencies of adjacent PRBs compared to values taken at subcarrier frequencies separated by two or more PRBs. Therefore, at the receiver for group-PRBs, after FD-OCC de-spreading operation (i.e., channel compression on the spectrum), average channel frequency characteristic estimate will differ less from that of actual frequency characteristics compared to PRB for CSI-RS distributed over the entire sub-band. This makes channel estimation more accurate in case of group PRBs.

PRBs blocks for CSI-RS transmission are defined as:

$$n = {N}_{CSI - RS}^{group} {n}^{′} + {m}^{′} , \qquad ( 5 )$$

where
m′=0, . . . , M_{PRB}^{CSI-RS,group}−1,
n′=0, 1, . . . ,
where n is the number of PRB, where CSI-RS is transmitted; N_{CSI-RS}^{group} is the number of PRBs that make up repetition period of M_{PRB}^{CSI-RS,group} consecutive PRB groups, where CSI-RS is transmitted; M_{PRB}^{CSI-RS,group} is the size of group (number of PRBs) of consecutive PRBs, where CSI-RS is transmitted, n′ is the PRB group index, and m′ is the PRB index inside PRB group.

Thus, the groups of PRBs are separated by same or similar distance in the frequency domain.

Periodicity in an embodiment is equal to the number of PRBs in one sub-band:

$${N}_{CSI - RS}^{group} = {N}_{PRB}^{Subband} .$$

The number of PRBs M_{PRB}^{CSI-RS,group} used to transmit CSI-RS in each sub-band is configured via RRC protocol: M_{PRB}^{CSI-RS,group}={1,2,3,4,5,6,7,all}.

Referring to FIG. 5C, it illustrates an alternative PRB distribution for CSI-RS with 0.25 density optimized for the sub-band structure according to an embodiment of the disclosure. In the example depicted, PRBs for CSI-RS are also grouped in the center of sub-band. Thereby channel coherence can be used to improve channel estimation performance.

In accordance with the disclosure, other PRB densities for CSI-RS can be used.

Therefore, the disclosure provides more efficient overhead reduction for CSI-RS transmission due to optimized PRBs allocation to CSI-RS sub-band. The overhead reduction is achieved, inter alia, by the fact that a smaller number of group PRBs in sub-band can be used to transmit CSI-RS than in case of CSI-RS of the related art with PRBs distributed across the sub-band, without losing the estimate quality of channel frequency and time characteristic.

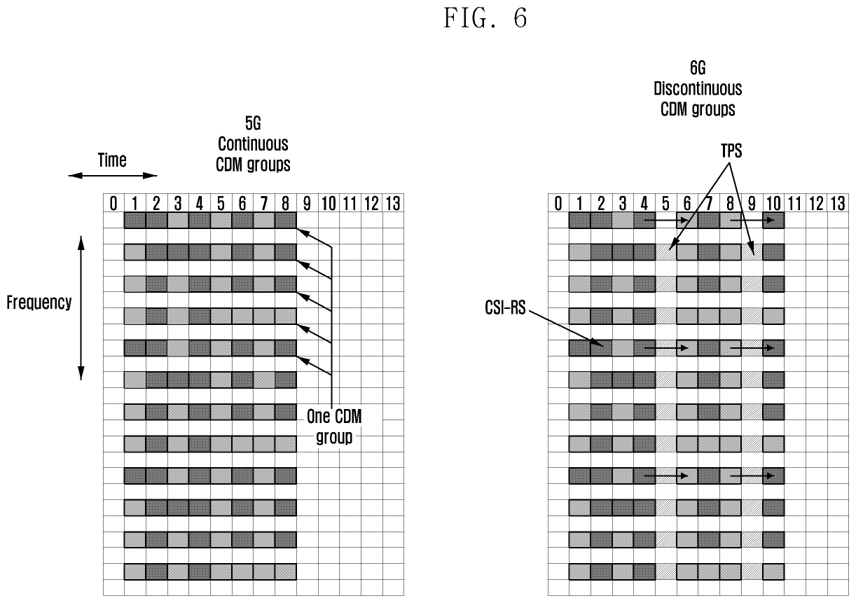

Referring now to FIG. 6, transmission of CSI-RS in case of collision with transmission of other reference signals in accordance with the disclosure is described.

In 5G NR, CSI-RS is continuously transmitted on adjacent OFDM symbols in slot (see FIG. 6, left side), and collision of CSI-RS transmission with the transmission of other reference signals is avoided at scheduling phase by selecting non-colliding resources for the transmissions, i.e., CDM groups are continuous in the time domain.

However, in 6G system, CSI-RS will apparently include a larger number of OFDM symbols, making difficult to schedule the resources to avoid CSI-RS transmissions from colliding with other reference signals. For this reason, in one embodiment of the disclosure, a discontinuous time-domain CSI-RS structure is provided in case of collision with other reference signals, i.e., CDM group is transmitted on non-adjacent OFDM symbols in slot.

FIG. 6 (right side) illustrates a CSI-RS structure in a time domain in case of collision with other reference signals in related art according to an embodiment of the disclosure.

Referring to FIG. 6, it illustrates a CSI-RS structure where CSI-RS transmission collides with transmission of other reference signals (such as tracking reference signal (TRS) or synchronization/physical broadcast channel signal (SS/PBCH)). In this case, a gap in the CSI-RS structure time domain is provided for transmission of the other reference signal. The gap can be defined:
implicitly, i.e., transmission of CSI-RS symbol is delayed, if collision with other reference signal is detected, to enable transmission of the other reference signal, i.e., the base station determines actual OFDM symbols for CSI-RS by delaying transmission of all or part of OFDM symbols of CSI-RS to later OFDM symbol, if collided with other signals (e.g., FIG. 6, right side, the fifth and ninth OFDM symbols transmit TRS signal, and CSI-RS transmission is delayed by the base station until subsequent OFDM symbols);
explicitly, when the base station configures/indicates OFDM symbols ({l₀, l₁, . . . , l_{Nt,max-1}} where CDM group of CSI-RS is transmitted (e.g., l₀=1, l₁=2, l₂=3, l₃=4, l₄=6, l₅=7, l₆=8, l₇=10 in FIG. 6, right side), i.e., actual OFDM symbols for CSI-RS are indicated in UE using signaling.

Thus, the disclosure provides more flexible scheduling of reference signal transmission and allows different reference signals to be transmitted in the same slot.

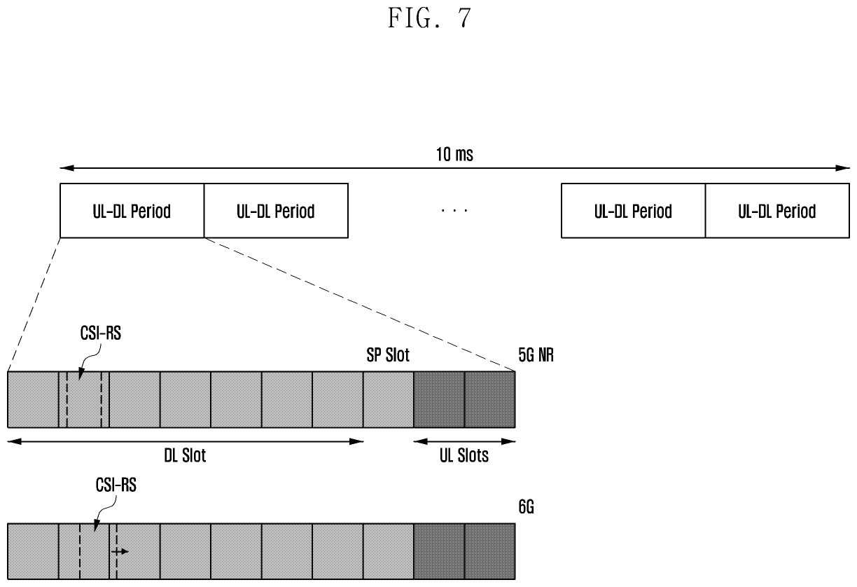

FIG. 7 illustrates CSI-RS transmission on two adjacent slots in 6G system according to an embodiment of the disclosure.

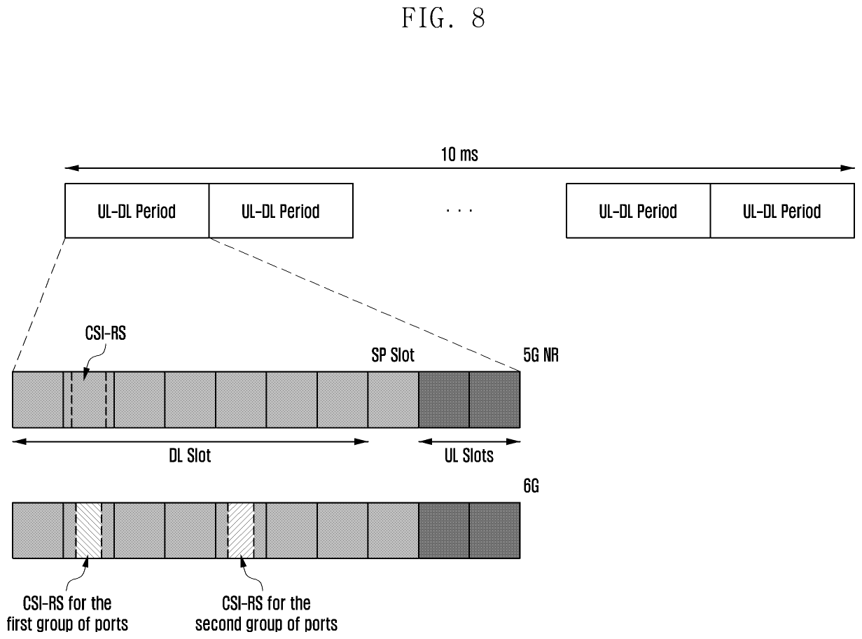

FIG. 8 illustrates CSI-RS transmission by two groups of antenna ports on two different slots in 6G system according to an embodiment of the disclosure.

Referring to FIGS. 7 and 8, options of CSI-RS transmission in multiple slots in accordance with the disclosure are described.

5G NR system provides CSI-RS transmission in a single slot.

However, due to possible increase in the CSI-RS size in 6G system and, therefore, complexity of its transmission in a single slot, an embodiment of the disclosure provides for CSI-RS transmission in more than one (e.g., two) adjacent slots (see FIG. 7) to increase scheduling flexibility of CSI-RS transmission resources and other signals in the time domain. Thus, the first and last CSI-RS symbols are in different slots. This embodiment also enables transmission of other signals in the same slot with such “split” CSI-RS signals.

For the same purpose, an alternative embodiment of the disclosure provides for the ability to divide antenna ports in the base station into two or more groups with CSI-RS transmitted to each of the antenna port groups in different slots (see FIG. 8). For example, ports with different polarizations can transmit signals in different slots. This embodiment provides more flexible transmission resource scheduling for CSI-RS and other signals in the time domain, and enables transmission of other signals in the same slot with the CSI-RS due to smaller CSI-RS resource size in the slot.

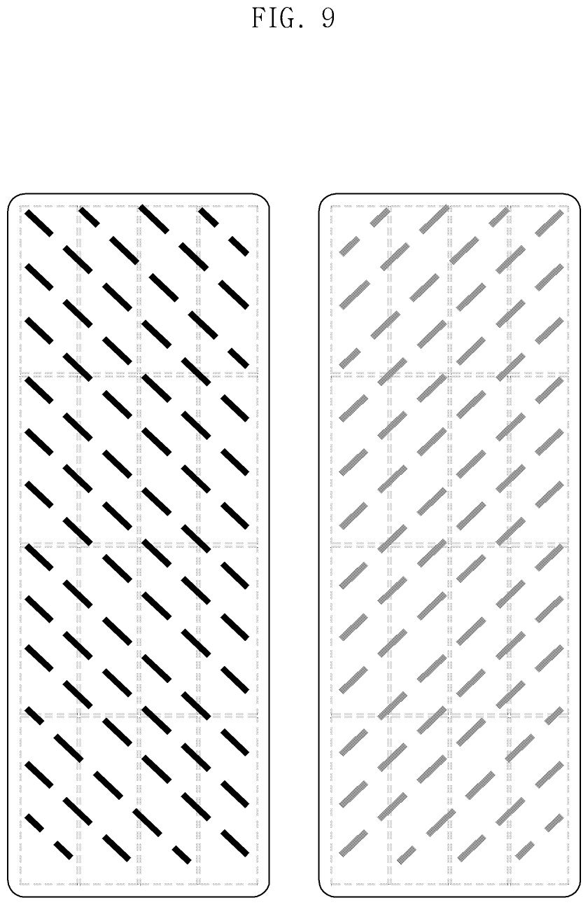

FIG. 9 illustrates schematically two groups of antenna ports for CSI-RS transmission in accordance with transmission embodiment depicted in FIG. 8 according to an embodiment of the disclosure.

Referring to FIG. 9, one group of antenna ports (FIG. 9, left side) has one polarization, and the other group of antenna ports (FIG. 9, right side) has a second polarization. Polarization of the antenna ports is schematically shown in FIG. 9 by two oblique lines per each antenna port.

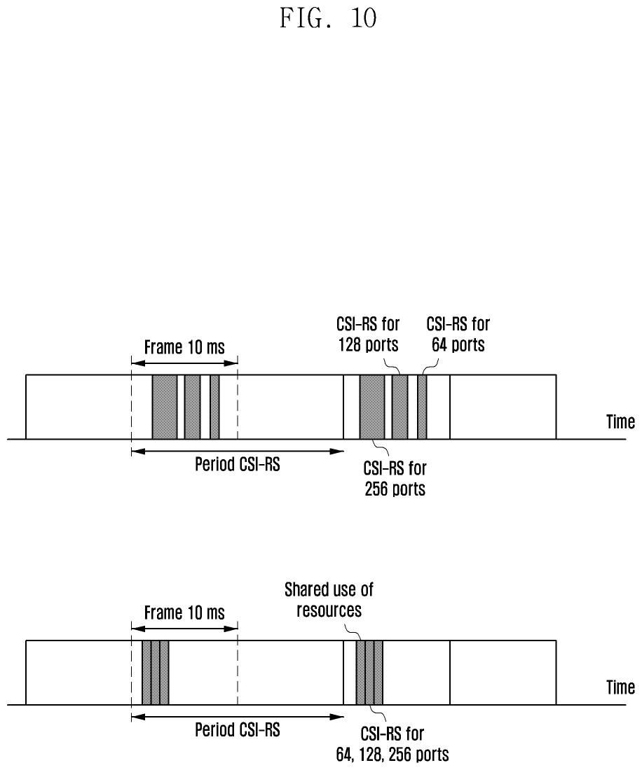

Due to limited computing power of user equipment and large number of antenna ports on the base station, where data is transmitted on multiple component carriers in a component carrier aggregation scenario, user equipment may not be able to calculate channel estimate from CSI-RS because the channel estimate is calculated for each component carrier. Then, a situation may arise where the base station must separately transmit multiple CSI-RSs for different numbers of antenna ports to different users depending on their computing power (FIG. 10, top). This significantly increases CSI-RS transmission overhead by the base station in communication system.

FIG. 10 is CSI-RS structure with resources shared for a different number of antenna ports according to an embodiment of the disclosure.

Referring to FIG. 10, in accordance with the disclosure, it is proposed that CSI-RS resources with smaller number of ports are subset of CSI-RS resources with larger number of ports. This allows sharing the CSI-RS resources to transmit signal to multiple users (see FIG. 10, bottom) taking into account their computing power. This reduces CSI-RS transmission overhead on the base station in communication system. Moreover, users will be able to receive only their corresponding CSI-RSs and estimate the channel.

In the disclosure, and, in particular, in the resource sharing embodiment of the disclosure, the following CSI-RS port indexing p is proposed: across CDM groups first, and then by OCC code inside CDM groups according to the equation:

$$p = i + s \cdot {N}_{CDM , max} \qquad Equation 6$$

where i=0, 1, . . . , N_{CDM,max}−1 the CDM group index, s=0, 1, . . . , N_{f,max}·N_{t,max}−1e code index inside the CDM group.

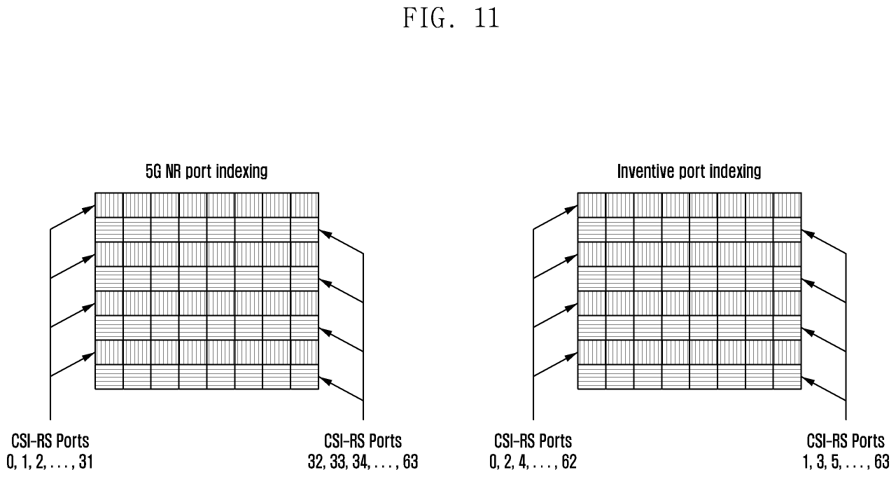

FIG. 11 is a schematic view illustrating indexing antenna ports for CSI-RS.

Referring to FIG. 11, it illustrates indexing antenna ports for CSI-RS structure in 5G NR (left side) and (right side) for the case where N_{CDM,max}=2 _(f,max)=4 and N_{t,max}=8cording to an embodiment of the disclosure. Thus, according to Equation 3, the maximum number of antenna ports for this CSI-RS structure is 64.

In this case, 5G NR ports with one polarization (ports 0, 1, 2, . . . , 31) transmit CSI-RS signals in one CDM group, and ports with other polarization (ports 32, 33, 34, . . . , 63) transmit CSI-RS signals in the second CDM group.

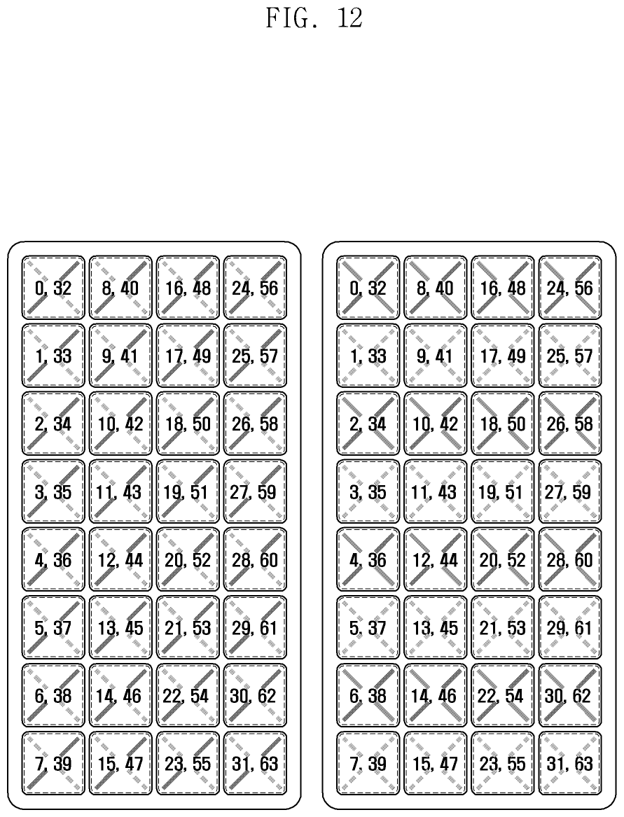

If user equipment supports only 32 ports and therefore receives only one CDM group from CSI-RSs for 64 ports transmitted by the base station for channel estimation, this user equipment receives signal from 32 one-polarized ports (FIG. 12, left side).

FIG. 12 is a schematic view illustrating antenna ports transmitting CSI-RSs received by user equipment in accordance with a signal structure of FIG. 11 according to an embodiment of the disclosure.

Referring to FIG. 12, base station ports, from which user equipment receives CSI-RS, are schematically denoted with solid diagonal lines. Ports, from which CSI-RS transmission is not received by user equipment, are schematically denoted by dotted diagonal lines. Slope of diagonal lines schematically indicates polarization of respective port.

The port indexing procedure of the disclosure (FIG. 11, right side) enables the user equipment supporting only 32 ports also receive from the CSI-RS for 64 ports transmitted by the base station only one CDM group for channel estimation, but the CDM group corresponds to 32 ports with both polarizations (FIG. 12, right side).

CSI-RS transmission and precoding from cross-polarized antenna ports provides better performance than CSI-RS from co-polarized antenna ports. For example, the use of two polarizations allows two MIMO layers to be transmitted, thereby increasing data transfer rate to user's device.

The CSI-RS generation method described herein and illustrated in FIGS. 4A, 4B, and 4C is used in communication systems to receive channel state information from user equipment by network base stations.

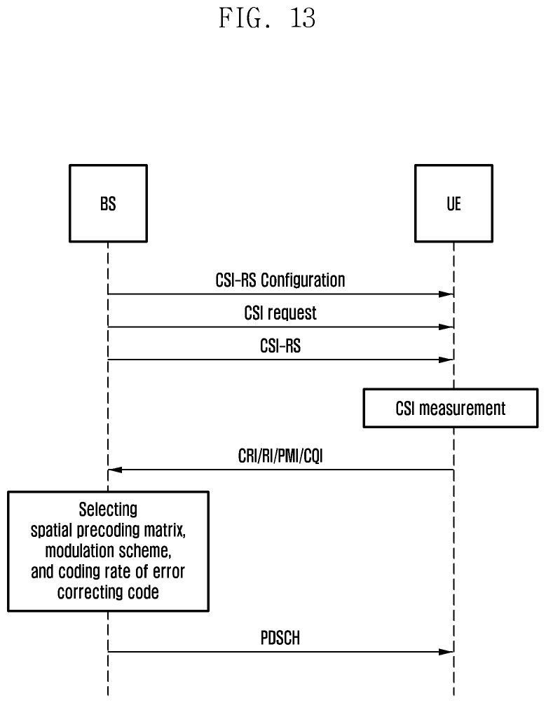

FIG. 13 is a flow diagram illustrating a method of communicating in communication system according to an embodiment of the disclosure.

Referring to FIG. 13, an example of a method for communicating in a communication system comprising at least one base station (BS) and at least one user equipment (UE) is described below, the method includes the aforementioned procedure for acquiring channel state information. First, the base station detects and transmits to user equipment configuration information with CSI-RS signal transmission parameters, which may include:
one or more code-division multiplexing (CDM) groups with uniform frequency distribution of resource elements (RE) in each CDM group (see FIG. 1);
total number of ports, number of CDM groups, OCC length by time and frequency (see Table 1);
CSI-RS port indexing information (see Equation 6);
used CSI-RS waveform (see FIGS. 4A, 4B, and 4C);
symbols used inside the slot (FIG. 6) or delayed CSI-RS transmission;
CSI-RS transmission in one or two adjacent slots (see FIG. 7);
transmission of group of ports in different slots (see FIGS. 8 and 9);
groups of physical resource blocks (PRBs), where CSI-RS is present (see FIGS. 5A, 5B, and 5C and Equation 5),
and other.

The base station then sends channel state information (CSI) request to user equipment.

Next, the base station generates CSI-RS signal for each antenna port of the base station (BS), modulated by orthogonal cover code (OCC) in the frequency domain (FD) across resource elements according to discrete Fourier transform (DFT) vector (see Equation 1) and in the time domain (TD) across one or more OFDM symbols according to Walsh-Hadamard code (WH) (see Equation 2). The base station then transmits the CSI-RS from antenna ports defined by Equation 6 according to the indicated CSI-RS transmission configuration parameters.

User equipment receives the CSI-RS reference signal based on the received CSI-RS configuration and measures channel characteristics from transmitting ports of the base station, thus acquiring channel state information. Further, this information is converted by the user into a set of indicators of the related art, such as CSI-RS resource indicator (CRI), rank indicator (RI), precoding matrix indicator (PMI), channel quality indicator (CQI), and sent via feedback channel to the base station. Having received the CSI channel state information from the user equipment, the base station, in turn, selects pre-coding spatial matrix, modulation scheme, and error correcting coding rate for physical downlink shared channel (PDSCH). The base station then generates and transmits signals in the PDSCH channel.

Thus, the disclosure can increase the number of supported antenna ports for CSI-RS up to 256, support various waveforms with common structure, e.g., CP-OFDM, and with low PAPR (e.g., OFDM with discrete Fourier transform spread (DFT-s-OFDM, OFDM)). The CSI-RS structure exhibits optimized overhead reduction with sub-band structure. Furthermore, the disclosure provides more flexible transmission of CSI-RS in different slots and in the same slot to match its transmission with other reference signals. In addition, the CSI-RS structure of the disclosure supports sharing CSI-RS resources.

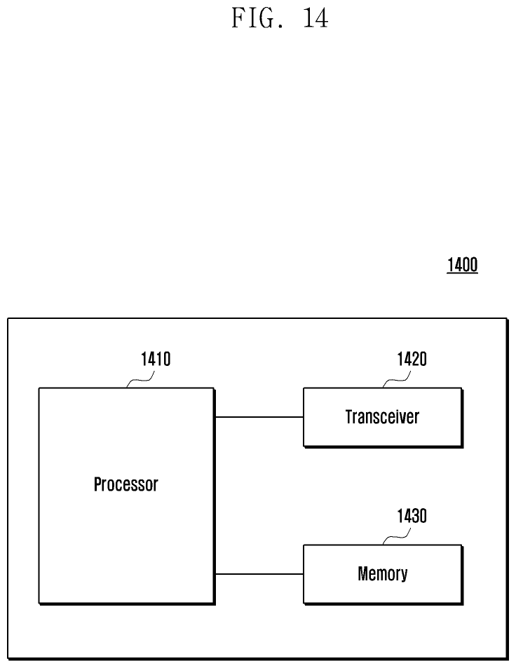

FIG. 14 is a block diagram of a terminal according to embodiments of the disclosure.

Referring to the FIG. 14, the terminal 1400 may include a processor 1410, a transceiver 1420 and a memory 1430. However, all of the illustrated components are not essential. The terminal 1400 may be implemented by more or less components than those illustrated in FIG. 14. In addition, the processor 1410 and the transceiver 1420 and the memory 1430 may be implemented as a single chip according to another embodiment.

The terminal 1400 may correspond to UE described above.

The aforementioned components will now be described in detail.

The processor 1410 may include one or more processors or other processing devices that control the proposed function, process, and/or method. Operation of the terminal 1400 may be implemented by the processor 1410.

The transceiver 1420 may include a RF transmitter for up-converting and amplifying a transmitted signal, and a RF receiver for down-converting a frequency of a received signal. However, according to another embodiment, the transceiver 1420 may be implemented by more or less components than those illustrated in components.

The transceiver 1420 may be connected to the processor 1410 and transmit and/or receive a signal. The signal may include control information and data. In addition, the transceiver 1420 may receive the signal through a wireless channel and output the signal to the processor 1410. The transceiver 1420 may transmit a signal output from the processor 1410 through the wireless channel.

The memory 1430 may store the control information or the data included in a signal obtained by the terminal 1400. The memory 1430 may be connected to the processor 1410 and store at least one instruction or a protocol or a parameter for the proposed function, process, and/or method. The memory 1430 may include read-only memory (ROM) and/or random access memory (RAM) and/or hard disk and/or CD-ROM and/or DVD and/or other storage devices.

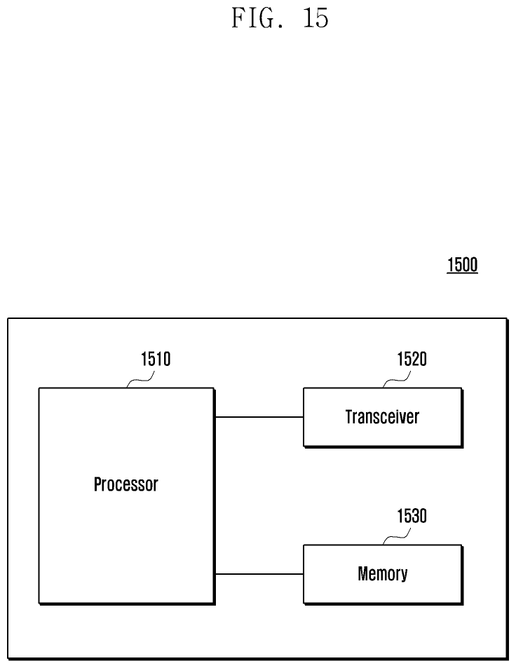

FIG. 15 is a base station according to embodiments of the disclosure.

Referring to the FIG. 15, the base station 1500 may include a processor 1510, a transceiver 1520 and a memory 1530. However, all of the illustrated components are not essential. The base station 1500 may be implemented by more or less components than those illustrated in FIG. 15. In addition, the processor 1510 and the transceiver 1520 and the memory 1530 may be implemented as a single chip according to another embodiment.

The aforementioned components will now be described in detail.

The processor 1510 may include one or more processors or other processing devices that control the proposed function, process, and/or method. Operation of the base station 1500 may be implemented by the processor 1510.

The transceiver 1520 may include a RF transmitter for up-converting and amplifying a transmitted signal, and a RF receiver for down-converting a frequency of a received signal. However, according to another embodiment, the transceiver 1520 may be implemented by more or less components than those illustrated in components.

The transceiver 1520 may be connected to the processor 1510 and transmit and/or receive a signal. The signal may include control information and data. In addition, the transceiver 1520 may receive the signal through a wireless channel and output the signal to the processor 1510. The transceiver 1520 may transmit a signal output from the processor 1510 through the wireless channel.

The memory 1530 may store the control information or the data included in a signal obtained by the base station 1500. The memory 1530 may be connected to the processor 1510 and store at least one instruction or a protocol or a parameter for the proposed function, process, and/or method. The memory 1530 may include read-only memory (ROM) and/or random access memory (RAM) and/or hard disk and/or CD-ROM and/or DVD and/or other storage devices.

Although this disclosure has been described with an exemplary embodiment, various changes and modifications may be suggested to one skilled in the art. It is intended that this disclosure encompass such changes and modifications as fall within the scope of the appended claims.

Another aspect of the disclosure provides a base station configured to set CSI-RS transmission configuration information including one or more CDM groups with uniform frequency distribution of resource elements (RE) in each CDM group, transmit the CSI-RS transmission configuration information to user equipment (UE), generate, for each antenna port of the base station, a CSI-RS modulated by OCC in the frequency domain (FD) across resource elements according to discrete Fourier transform (DFT) vector and in the time domain (TD) across one or more OFDM symbols according to Walsh-Hadamard (WH) code, and transmit the CSI-RS to the UE according to the CSI-RS transmission configuration.

Yet another aspect of the disclosure provides a computer-readable medium comprising a program which, when executed by at least one processor, causes the at least one processor to perform the described above method for transmitting CSI-RS in accordance with the disclosure.

User equipment (UE) described herein, depending on the embodiment of the disclosure, may be a terminal, a mobile station (MS), an advanced mobile station (AMS), or the like. Furthermore, base station (BS) is a generic name for a network architecture node communicating with user equipment, such as Node B (NB), eNode B (eNB), access point (AP), gNode B, or the like.

The above description is applicable to a variety of wireless communication systems, including code division multiple access (CDMA), frequency division multiple access (FDMA), time division multiple access (TDMA), orthogonal frequency division multiple access TDMA), single carrier frequency division multiple access (SC-FDMA), and the like. OFDMA can be implemented using wireless framework, such as institute of electrical and electronics engineers (IEEE) 802.11 (Wi-Fi), IEEE 802.16 (worldwide interoperability for microwave access (WiMAX)), IEEE 802.20, evolved-universal terrestrial radio access network (E-UTRA), or the like, UTRA is part of universal mobile telecommunications system (UMTS). Long term development (LTE) 3^{rd} generation partnership project (3GPP) is part of evolved UMTS (E-UMTS), which uses E-UTRA. 3GPP LTE uses OFDMA in DL and SC-FDMA in UL, and advanced LTE (LTE-A) is an advanced version of 3GPP LTE. CDMA can be implemented using wireless framework, such as universal terrestrial access (UTRA), CDMA 2000 and the like. TDMA can be implemented using wireless framework, such as GSM/GPRS/EDGE (global system for mobile communications)/general purpose packet radio/enhanced data rates for GSM development).

Each of base station and user equipment of the disclosure supports multiple input/multiple output (MIMO) system. Base station of the disclosure can support both single-user MIMO (SU-MIMO) and multi-user MIMO (MU-MIMO) systems.

It should be understood that while terms, such as “first”, “second”, “third”, or the like, may be used herein to describe various elements, components, regions, layers, and/or sections, these elements, components, regions, layers, and/or sections should not be limited to these terms. These terms are used only to distinguish one element, component, region, layer, or section from another element, component, region, layer, or section. Thus, first element, component, region, layer, or section may be referred to as second element, component, region, layer, or section without going beyond the scope of the disclosure. As used herein, the term “and/or” includes any and all combinations of one or more of relevant listed items.

Functionality of an element specified in the description or claims as a single element may be implemented in practice by multiple components of the device, and conversely, functionality of elements specified in the description or claims as several separate elements may be implemented in practice by a single element.

Embodiments of the disclosure are not limited to the embodiments described herein. Other embodiments of the disclosure that do not go beyond the idea and scope of the disclosure will become apparent to a person skilled in the art based on the information provided in the description and related art knowledge.

The person skilled in the art will appreciate that the idea of the disclosure is not limited to a particular software or hardware implementation, and therefore any software and hardware known in the art may be used to carry out the disclosure. Thus, the hardware may be implemented in one or more specialized integrated circuits, digital signal processors, digital signal processing devices, programmable logic devices, field-programmable gate arrays, processors, controllers, microcontrollers, microprocessors, electronic devices, other electronic modules configured to perform the functions described herein, computer, or combinations thereof.

It is apparent that reference to storage of data, programs, or the like, implies the provision of a computer-readable data medium. Examples of computer-readable storage media include read-only memory, random access memory, register, cache memory, solid-state storage devices, magnetic media, such as internal hard drives and removable disks, magneto-optical media and optical media, such as compact disc read only memory (CD-ROM) and digital versatile discs (DVDs), and any other data media known in the art.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a base station in a wireless communication system, the method comprising:
transmitting, to a terminal, channel state information-reference signal (CSI-RS) transmission configuration information including one or more code-division multiplexing (CDM) groups with uniform frequency distribution of resource elements (RE) in each CDM group;
transmitting, to the terminal, CSI-RS generated for each antenna port of the base station based on the CSI-RS transmission configuration, wherein the CSI-RS is modulated by an orthogonal cover code (OCC) in frequency domain (FD) across resource elements based on discrete Fourier transform (DFT) vector and in time domain (TD) across one or more orthogonal frequency-division multiplexing (OFDM) symbols based on Walsh-Hadamard (WH) code; and
receiving, from the terminal, channel state information based on the CSI-RS.

2. The method of claim 1,
wherein the CSI-RS transmission configuration information further includes at least one of information on a number of ports, information on a number of the CDM groups, a length of an OCC in time and frequency, CSI-RS port indexing information, CSI-RS waveform, OFDM symbols and slots used for the CSI-RS, or physical resource block (PRB) groups where CSI-RS is present,
wherein the PRB groups comprises two or more adjacent PRBs, the PRB groups being separated from each other by a same or similar distance in the frequency domain, and
wherein antenna ports for CSI-RS is indexed in an order of first, across the CDM groups, and second, by an OCC in the CDM groups.

3. The method of claim 1,
wherein the CSI-RS is generated by modulating a CSI-RS sequence by one of quadrature phase shift keying (QPSK) symbols, π/2 binary phase shift key (π/2-BPSK) symbols, or by a Zadoff-Chu (ZC) sequence, and
wherein the QPSK symbols and π/2-BPSK symbols are obtained based on a pseudo random sequence.

4. The method of claim 1,
wherein a CDM group is transmitted on non-adjacent OFDM symbols in a slot,
wherein, in case that the CSI-RS is collided with another signal, actual OFDM symbols for the CSI-RS are determined by delaying a subsequent transmission of all or a part of the OFDM symbols for the CSI-RS to a next OFDM symbol,
wherein, information on the actual OFDM symbols for the CSI-RS are indicated to the terminal, and
wherein the other signal includes a tracking reference signal (TRS).

5. The method of claim 1,
wherein a first symbol and a last symbol of the CSI-RS are on different slots,
wherein a first subset of CSI-RS ports are transmitted on a first slot and a second subset of CSI-RS ports are transmitted on a second slot,
wherein a polarization of the first subset of the CSI-RS ports is different from a polarization of the second subset of the CSI-RS ports, and
wherein a first CSI-RS corresponding to smaller number of antenna ports is a subset of a second CSI-RS corresponding to larger number of antenna ports.

6. A method performed by a terminal in a wireless communication system, the method comprising:
receiving, from a base station, channel state information-reference signal (CSI-RS) transmission configuration information including one or more code-division multiplexing (CDM) groups with uniform frequency distribution of resource elements (RE) in each CDM group;
receiving, from the base station, CSI-RS based on the CSI-RS transmission configuration, wherein the CSI-RS is modulated by an orthogonal cover code (OCC) in frequency domain (FD) across resource elements based on discrete Fourier transform (DFT) vector and in time domain (TD) across one or more orthogonal frequency-division multiplexing (OFDM) symbols based on Walsh-Hadamard (WH) code; and
transmitting, to the base station, channel state information based on a measurement for the CSI-RS.

7. The method of claim 6,
wherein the CSI-RS transmission configuration information further includes at least one of information on a number of ports, information on a number of the CDM groups, a length of an OCC in time and frequency, CSI-RS port indexing information, CSI-RS waveform, OFDM symbols and slots used for the CSI-RS, or physical resource block (PRB) groups where CSI-RS is present,
wherein the PRB groups comprises two or more adjacent PRBs, the PRB groups being separated from each other by a same or similar distance in the frequency domain, and
wherein antenna ports for CSI-RS is indexed in an order of first, across the CDM groups, and second, by an OCC in the CDM groups.

8. The method of claim 6,
wherein the CSI-RS is based on modulation of a CSI-RS sequence by one of quadrature phase shift keying (QPSK) symbols, π/2 binary phase shift key (π/2-BPSK) symbols, or by a Zadoff-Chu (ZC) sequence, and
wherein the QPSK symbols and π/2-BPSK symbols are obtained based on a pseudo random sequence.

9. The method of claim 6,
wherein a CDM group is received on non-adjacent OFDM symbols in a slot,
wherein, in case that the CSI-RS is collided with another signal, actual OFDM symbols for the CSI-RS are determined by delaying a subsequent transmission of all or a part of the OFDM symbols for the CSI-RS to a next OFDM symbol,
wherein, information on the actual OFDM symbols for the CSI-RS are indicated to the terminal, and
wherein the other signal includes a tracking reference signal (TRS).

10. The method of claim 6,
wherein a first symbol and a last symbol of the CSI-RS are on different slots,
wherein a first subset of CSI-RS ports are received on a first slot and a second subset of CSI-RS ports are transmitted on a second slot,
wherein a polarization of the first subset of the CSI-RS ports is different from a polarization of the second subset of the CSI-RS ports, and
wherein a first CSI-RS corresponding to smaller number of antenna ports is a subset of a second CSI-RS corresponding to larger number of antenna ports.

11. A base station in a wireless communication system, the base station comprising:
a transceiver; and
a controller configured to:
control the transceiver to transmit, to a terminal, channel state information-reference signal (CSI-RS) transmission configuration information including one or more code-division multiplexing (CDM) groups with uniform frequency distribution of resource elements (RE) in each CDM group,
control the transceiver to transmit, to the terminal, CSI-RS generated for each antenna port of the base station based on the CSI-RS transmission configuration, wherein the CSI-RS is modulated by an orthogonal cover code (OCC) in frequency domain (FD) across resource elements based on discrete Fourier transform (DFT) vector and in time domain (TD) across one or more orthogonal frequency-division multiplexing (OFDM) symbols based on Walsh-Hadamard (WH) code, and
control the transceiver to receive, from the terminal, channel state information based on the CSI-RS.

12. The base station of claim 11,
wherein the CSI-RS transmission configuration information further includes at least one of information on a number of ports, information on a number of the CDM groups, a length of an OCC in time and frequency, CSI-RS port indexing information, CSI-RS waveform, OFDM symbols and slots used for the CSI-RS, or physical resource block (PRB) groups where CSI-RS is present,
wherein the PRB groups comprises two or more adjacent PRBs, the PRB groups being separated from each other by a same or similar distance in the frequency domain, and
wherein antenna ports for CSI-RS is indexed in an order of first, across the CDM groups, and second, by an OCC in the CDM groups.

13. The base station of claim 11,
wherein the CSI-RS is generated by modulating a CSI-RS sequence by one of quadrature phase shift keying (QPSK) symbols, π/2 binary phase shift key (π/2-BPSK) symbols, or by a Zadoff-Chu (ZC) sequence, and
wherein the QPSK symbols and π/2-BPSK symbols are obtained based on a pseudo random sequence.

14. The base station of claim 11,
wherein a CDM group is transmitted on non-adjacent OFDM symbols in a slot,
wherein, in case that the CSI-RS is collided with another signal, actual OFDM symbols for the CSI-RS are determined by delaying a subsequent transmission of all or a part of the OFDM symbols for the CSI-RS to a next OFDM symbol,
wherein, information on the actual OFDM symbols for the CSI-RS are indicated to the terminal, and
wherein the other signal includes a tracking reference signal (TRS).

15. The base station of claim 11,
wherein a first symbol and a last symbol of the CSI-RS are on different slots,
wherein a first subset of CSI-RS ports are transmitted on a first slot and a second subset of CSI-RS ports are transmitted on a second slot,
wherein a polarization of the first subset of the CSI-RS ports is different from a polarization of the second subset of the CSI-RS ports, and
wherein a first CSI-RS corresponding to smaller number of antenna ports is a subset of a second CSI-RS corresponding to larger number of antenna ports.

16. A terminal in a wireless communication system, the terminal comprising:
a transceiver; and
a controller configured to:
control the transceiver to receive, from a base station, channel state information-reference signal (CSI-RS) transmission configuration information including one or more code-division multiplexing (CDM) groups with uniform frequency distribution of resource elements (RE) in each CDM group,
control the transceiver to receive, from the base station, CSI-RS based on the CSI-RS transmission configuration, wherein the CSI-RS is modulated by an orthogonal cover code (OCC) in frequency domain (FD) across resource elements based on discrete Fourier transform (DFT) vector and in time domain (TD) across one or more orthogonal frequency-division multiplexing (OFDM) symbols based on Walsh-Hadamard (WH) code, and
control the transceiver to transmit, to the base station, channel state information based on a measurement for the CSI-RS.

17. The terminal of claim 16,
wherein the CSI-RS transmission configuration information further includes at least one of information on a number of ports, information on a number of the CDM groups, a length of an OCC in time and frequency, CSI-RS port indexing information, CSI-RS waveform, OFDM symbols and slots used for the CSI-RS, or physical resource block (PRB) groups where CSI-RS is present,
wherein the PRB groups comprises two or more adjacent PRBs, the PRB groups being separated from each other by a same or similar distance in the frequency domain, and
wherein antenna ports for CSI-RS is indexed in an order of first, across the CDM groups, and second, by an OCC in the CDM groups.

18. The terminal of claim 16,
wherein the CSI-RS is based on modulation of a CSI-RS sequence by one of quadrature phase shift keying (QPSK) symbols, π/2 binary phase shift key (π/2-BPSK) symbols, or by a Zadoff-Chu (ZC) sequence, and
wherein the QPSK symbols and π/2-BPSK symbols are obtained based on a pseudo random sequence.

19. The terminal of claim 16,
wherein a CDM group is received on non-adjacent OFDM symbols in a slot,
wherein, in case that the CSI-RS is collided with another signal, actual OFDM symbols for the CSI-RS are determined by delaying a subsequent transmission of all or a part of the OFDM symbols for the CSI-RS to a next OFDM symbol,
wherein, information on the actual OFDM symbols for the CSI-RS are indicated to the terminal, and
wherein the other signal includes a tracking reference signal (TRS).

20. The terminal of claim 16,
wherein a first symbol and a last symbol of the CSI-RS are on different slots,
wherein a first subset of CSI-RS ports are received on a first slot and a second subset of CSI-RS ports are transmitted on a second slot,
wherein a polarization of the first subset of the CSI-RS ports is different from a polarization of the second subset of the CSI-RS ports, and
wherein a first CSI-RS corresponding to smaller number of antenna ports is a subset of a second CSI-RS corresponding to larger number of antenna ports.
